(19) United States
(12) Patent Application Publication
(10) Pub. No.: US 2008/0018956 A1
(43) Pub. Date: Jan. 24, 2008

(54) IMAGE SCANNING DEVICE

(75) Inventor: Hirokazu INOUE, Kyoto-shi (JP)

Correspondence Address: MURATA MACHINERY, LTD.;(MURATEC) c/o KEATING & BENNETT LLP, 8180 GREENSBORO DRIVE, SUITE 850, MCLEAN, VA, 22102, US

(73) Assignee: MURATA KIKAI KABUSHIKI KAISHA, Fushimi-ku (JP)

(21) Appl. No.: 11/619,769

(22) Filed: Jan. 4, 2007

(30) Foreign Application Priority Data
Feb. 7, 2006 (JP) 2006-029542

(51) Int. Cl. H04N 1/04

(52) U.S. Cl. 358/474

(57) ABSTRACT

A digital multi function peripheral functions as a flatbed image scanning device which scans an image of an original document placed on a platen glass. The digital multi function peripheral includes a plastic chassis, which also functions as an outer casing, and a metal frame, which is arranged in a ladder shape by welding bridge members to a separated pair of guide rails. The metal frame is built in the chassis.

### RELATED APPLICATION

This application claims priority under 35 U.S.C. 119 to Japanese Patent Application No. 2006-029542, filed on Feb. 7, 2006, which application is hereby incorporated by reference in its entirety.

### BACKGROUND OF THE INVENTION

1. Field of the Invention

The present invention relates to a flatbed image scanning device.

2. Description of the Related Art

A digital multi function peripheral having a scanner function, a printer function, a copy function, and a facsimile function includes a flatbed image scanning portion. Conventionally, the image scanning portion includes a metal chassis in order to achieve rigidity and accuracy. The chassis is covered with a cover made of plastic or resin, hereinafter simply referred to as plastic.

However, the plastic cover of the conventional image scanning device is formed of many plastic members, contributing to an increase of a number of components used in the image scanning device.

### SUMMARY OF THE INVENTION

In order to overcome the above-described problem, preferred embodiments of the present invention reduce the number of components used in an image scanning device while maintaining rigidity and accuracy.

A first preferred embodiment of the present invention is a flatbed image scanning device which scans an image of an original document placed on a platen glass. The flatbed image scanning device includes a plastic chassis and a metal frame. The plastic chassis also functions as an outer casing of the image scanning device. The metal frame is arranged in a ladder shape by welding a group of bridge members to a separated pair of elongated members. The metal frame is built in the plastic chassis.

In a second preferred embodiment of the present invention, a carriage forms an image scanning optical system, which scans an original document placed on the platen glass. The carriage is transported along the platen glass by transport belts. The transport belts are supported by supporting portions. The supporting portions are held by the metal frame.

In a third preferred embodiment of the present invention, the carriage, which forms the image scanning optical system that scans the original document placed on the platen glass, travels on an upper surface of the pair of the elongated members.

According to the first to the third preferred embodiments of the present invention, while maintaining rigidity and accuracy, the number of components used in the image scanning device can be reduced. As a result, the image scanning device can be manufactured economically. In addition, since sealing of the image scanning device can be increased, dust and static charge can be prevented from accumulating in the image scanning device more reliably.

According to the second preferred embodiment of the present invention, since the supporting portions are held by the metal frame, which does not expand or contract greatly during temperature changes, an image scanning accuracy is less likely to be affected by the temperature changes.

According to the third preferred embodiment of the present invention, since the carriage travels on the upper surface of the pair of the elongated members of the metal frame, which does not expand or contract greatly during the temperature changes, the image scanning accuracy is less likely to be affected by the temperature changes.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a perspective view illustrating an external structure of an upper portion of a digital multi function peripheral according to a preferred embodiment of the present invention.

FIG. 2 is a perspective view illustrating an internal structure of an image scanning portion.

FIG. 3 is a perspective view of a chassis.

FIG. 4 is a perspective view illustrating a structure of a metal frame.

FIG. 5 is a perspective view of a supporting bracket held by a metal frame.

### DETAILED DESCRIPTION OF PREFERRED EMBODIMENTS

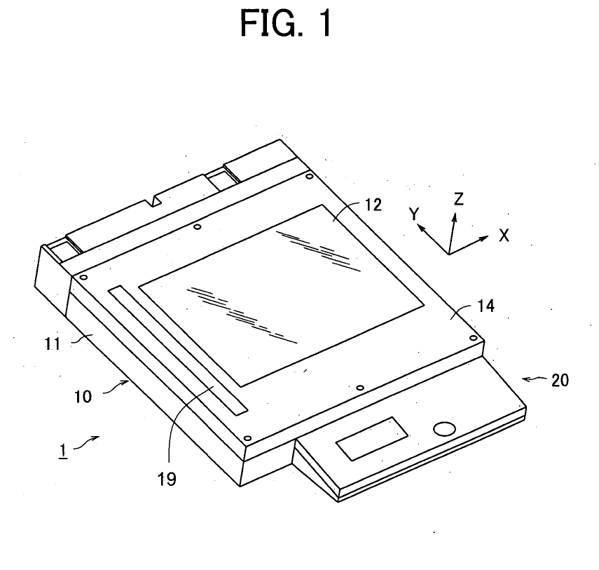

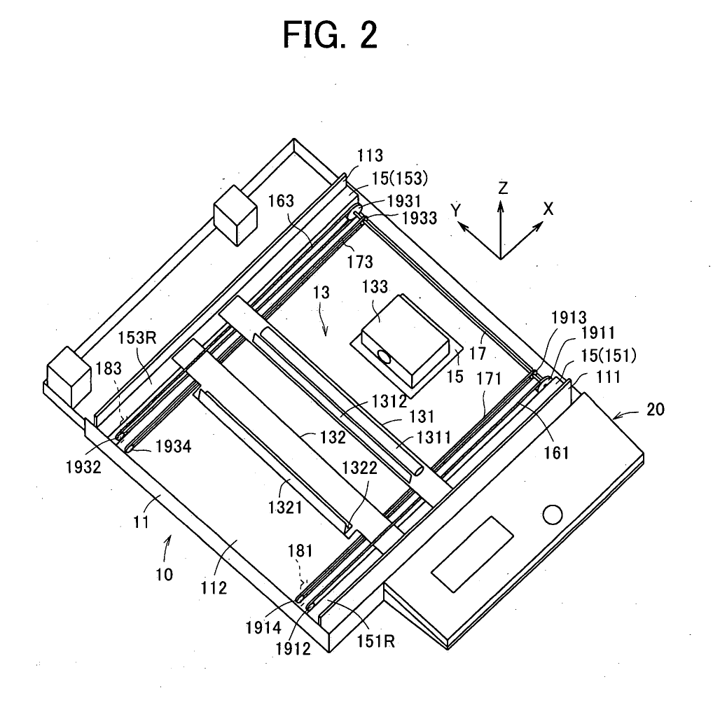

FIG. 1 is a schematic perspective view illustrating an external structure of an upper portion of a digital multi function peripheral (MFP) 1 according to a preferred embodiment of the present invention. For convenience, an X-Y-Z orthogonal coordinate system is defined in FIG. 1 in which an X-axis direction extends in a right-left direction, a Y-axis direction extends in a front-back direction, and a Z-axis direction extends in a top-bottom direction. This definition can also be applied to the following descriptions of FIGS. 2 to 5.

The digital MFP 1 includes a scanner function, a printer function, a copy function, and a facsimile function. The digital MFP 1 functions as an image scanning device which scans an image of an original document. As illustrated in FIG. 1, an image scanning portion 10 and an operation panel 20 are mounted on an upper portion of the digital MFP 1. An image forming portion (not illustrated) is provided in a lower portion of the digital MFP 1.

The image scanning portion 10 functions as a flatbed image scanning portion, which scans an image of an original document placed on a platen glass 12 and generates image data relating to the image. The image scanning portion 10 also functions as an auto document feeding image scanning portion, which scans an image of an original document fed onto a contact glass 19 by an auto document feeder built in a document pressing cover (not illustrated) and generates image data relating to the image.

The operation panel 20 is used not only to operate the digital MFP 1 but also to confirm an operation status and a setting of the digital MFP 1.

The image forming portion (not illustrated) provided below the image scanning portion 10 forms an image relating to the image data on a recording medium such as a recording paper by an electrophotographic system. More specifically, the image forming portion develops an electrostatic latent image, which has been formed on a surface of a photoconductive drum, by toner, and transfers the toner from the photoconductive drum onto the recording medium. Accordingly, an image relating to the image data is formed on the recording medium.

Next, with reference to FIG. 2, a description will be made of an internal structure of the image scanning portion 10. FIG. 2 is a schematic perspective view illustrating the image scanning portion 10 under a state in which the platen glass 12, the contact glass 19, and a plastic top cover 14, which is fixed on a chassis 11 by screws, have been removed.

The image scanning portion 10 includes the chassis 11 as a framework, a metal frame 15 which reinforces the chassis 11, and an image scanning optical system 13 which scans the original document placed on the platen glass 12.

The chassis 11 is a plastic chassis which also functions as an outer casing of the image scanning device 1, and is preferably formed of a single plastic member.

In the chassis 11, a front bulkhead 111 and a rear bulkhead 113, which are separated in the Y-axis direction, vertically project from a bottom surface 112, which is parallel to the XY plane. Two opposing marginal portions of the rectangular platen glass 12 are respectively supported by an upper edge of the front bulkhead 111 and the rear bulkhead 113 extending in the X-axis direction. The platen glass 12 is provided between the front bulkhead 111 and the rear bulkhead 113.

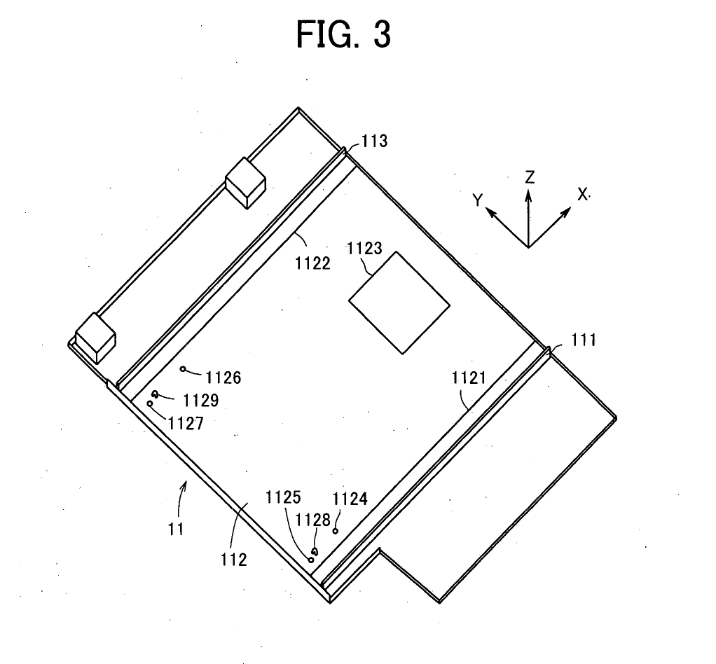

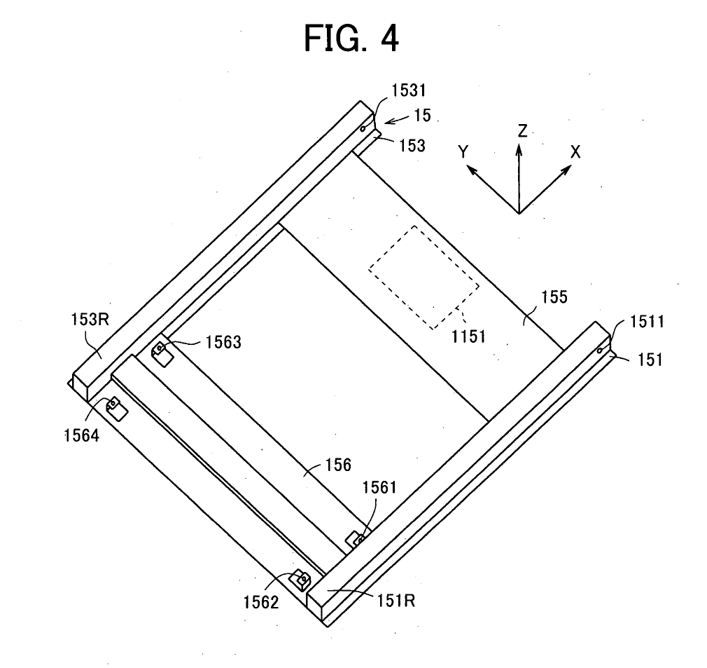

As illustrated in the perspective view of FIG. 3, elongated embedding holes 1121 and 1122 are provided in the bottom surface 112 of the chassis 11. The metal frame 15, in particular, guide rails 151 and 153, project upwards from below the chassis 11 through the elongated embedding holes 1121 and 1122. An exposing hole 1123, which exposes a scanner unit attaching portion 1151 (refer to FIG. 4) of the metal frame 15, is provided in the bottom surface 112 of the chassis 11. In addition, round holes 1124, 1125, 1126, and 1127 are provided in the bottom surface 112. Screws SC1 and SC2 are inserted through the round holes 1124, 1125, 1126, and 1127 to fix supporting brackets 181 and 183 (to be described hereinafter) on the metal frame 15. Hooks 1128 and 1129 are also formed on the bottom surface 112, and a coil spring 1839 (to be described hereinafter) can be hooked on the hooks 1128 and 1129.

As illustrated in the perspective view of FIG. 4, the metal frame 15 is arranged in a ladder shape by welding bridge members 155 and 156 to the guide rails 151 and 153, which are a separated pair of elongated members. By embedding the guide rails 151 and 153, respectively, in the embedding holes 1121 and 1122 of the chassis 11, the metal frame 15 is built in the chassis 11. Screw holes 1561, 1562, 1563, and 1564, which are used to fix the supporting brackets 181 and 183 (to be described hereinafter), are provided in the bridge member 156.

As illustrated in FIG. 2, the image scanning optical system 13, which scans an image of an original document placed on the platen glass 12, is provided in a space between the front bulkhead 111 and the rear bulkhead 113. The image scanning optical system 13 includes a full-rate carriage 131, a half-rate carriage 132, and a scanner unit 133.

The full-rate carriage 131 is a mirror carriage, which integrates a bar-shaped light source 1311 and a rectangular mirror 1312 both extending in the Y-axis direction. The full-rate carriage 131 is movably supported on upper surfaces 151R and 153R (hereinafter referred to as rail surfaces 151R and 153R) of the guide rails 151 and 153, and can travel on the rail surfaces 151R and 153R in the X-axis direction. The full-rate carriage 131 emits light from the light source 1311 onto the original document placed on the platen glass 12, and guides the light from the original document towards the half-rate carriage 132 by reflecting the light from the original document by the mirror 1312.

The half-rate carriage 132 is a mirror carriage, which integrates rectangular mirrors 1321 and 1322 both extending in the Y direction. The half-rate carriage 132 is movably supported on the rail surfaces 151R and 153R, and can travel on the rail surfaces 151R and 153R in the X-axis direction. The half-rate carriage 132 reflects the light from the full-rate carriage 131 by the mirrors 1321 and 1322, and guides the light towards the scanner unit 133.

The scanner unit 133 is fixed to the scanner unit attaching portion 1151 of the metal frame 15. The scanner unit 133 receives the light from the half-rate carriage 132, and generates an image signal relating to the image.

The full-rate carriage 131 is fixed to circular-shaped rubber transport belts 161 and 163, which are separated in the Y-axis direction, and is transported in the X-axis direction in response to a rotating movement of the transport belts 161 and 163. In a similar manner, the half-rate carriage 132 is fixed to circular-shaped rubber transport belts 171 and 173, which are separated in the Y-axis direction, and is transported in the X-axis direction in response to a rotating movement of the transport belts 171 and 173. In the image scanning optical system 13, the full-rate carriage 131 is transported along the platen glass 12 at a prescribed speed, and synchronized with the full-rate carriage 131, the half-rate carriage 132 is transported along the platen glass 12 at a half speed of the full-rate carriage 131. By transporting both the carriages 131 and 132 in the above-described manner, the image scanning optical system 13, while maintaining a light path length, scans the original document placed on the platen glass 12 in the X-axis direction and scans the image of the original document. The material of the transport belts 161, 163, 171, and 173 is not limited to rubber, but can be polyurethane, for example.

The transport belt 161 is wound around a driving pulley 1911 and a driven pulley 1912, which are spaced away from one another in the X-axis direction. The transport belt 161 is provided along the guide rail 151. The transport belt 171 is wound around a driving pulley 1913 and a driven pulley 1914, which are spaced away from one another in the X-axis direction. The transport belt 171 is also provided along the guide rail 151.

The transport belt 163 is wound around a driving pulley 1931 and a driven pulley 1932, which are spaced away from one another in the X-axis direction. The transport belt 163 is provided along the guide rail 153. The transport belt 173 is wound around a driving pulley 1933 and a driven pulley 1934, which are spaced away from one another in the X-axis direction. The transport belt 173 is also provided along the guide rail 153.

The driving pulleys 1911, 1913, 1931, and 1933 are held on a shaft 17 extending in the Y-axis direction. The driving pulleys 1911, 1913, 1931, and 1933 are axially rotated around the shaft 17 by a motor (not illustrated). The shaft 17 is rotatably held by shaft inserting holes 1511 and 1531 respectively provided in side surfaces of the guide rails 151 and 153. A pulley diameter of the driving pulleys 1913 and 1933, on which the transport belts 171 and 173 are wound for transporting the half-rate carriage 132, is half of a pulley diameter of the driving pulleys 1911 and 1931, on which the transport belts 161 and 163 are wound for transporting the full-rate carriage 131. Therefore, in the image scanning portion 10, the half-rate carriage 132 can be transported at half the speed of the full-rate carriage 131.

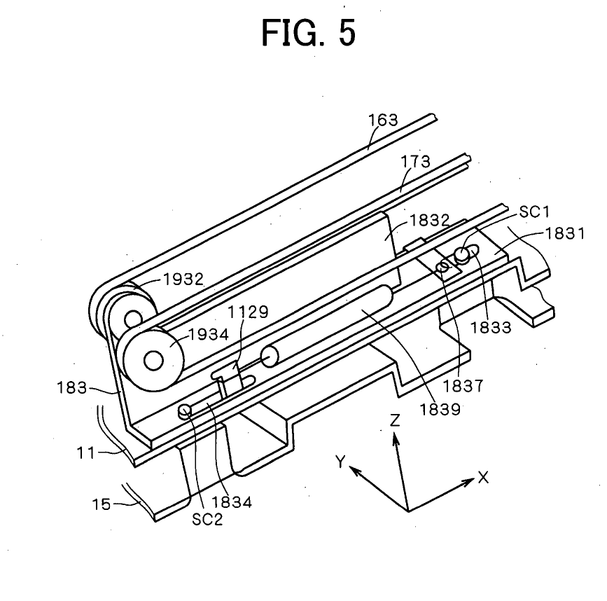

The driven pulleys 1932 and 1934 are rotatably supported by the supporting bracket 183 held on the metal frame 15. The driven pulleys 1912 and 1914 are rotatably supported by the supporting bracket 181 held on the metal frame 15. With reference to the perspective view of FIG. 5, a description will be made of the supporting bracket 183. The supporting bracket 183 includes a horizontal portion 1831 and a vertical portion 1832. The horizontal portion 1831 is fixed by screws to the metal frame 15 by sandwiching the chassis 11 between the horizontal portion 1831 and the metal frame 15. The vertical portion 1832 axially supports the driven pulleys 1932 and 1934.

Long holes 1833 and 1834, both extending in the X-axis direction, are provided in the horizontal portion 1831 of the supporting bracket 183. The supporting bracket 183 is fixed to the metal frame 15 by screwing the screw SC1, which has been inserted through the long hole 1833 and the round hole 1126, into a screw hole 1563, and screwing the screw SC2, which has been inserted through the long hole 1834 and the round hole 1127, into a screw hole 1564. The hook 1129, which is integrally formed with the chassis 11, is inserted through the long hole 1834. The coil spring 1839, which determines tension of the transport belts 163 and 173, is bridged between the hook 1129 and a spring receiving portion 1837 formed on the supporting bracket 183.

The supporting portions that support the transport belts 161, 163, 171 and 173, that is, the driving pulleys 1911, 1913, 1931 and 1933, the shaft 17, the driven pulleys 1912, 1914, 1932 and 1934, and the supporting brackets 181 and 183, are held by the metal frame 15, which does not expand or contract greatly accompanying the temperature changes. Accordingly, the screws SC1 and SC2 can be slackened when the tension of the elastic transport belts 161, 163, 171 and 173 changes accompanying the temperature changes. Since slackening of the screws SC1 and SC2 acts upon the coil spring 1839, the tension can be easily controlled, and the image scanning accuracy can be less likely to be affected by the temperature changes.

In addition, in the image scanning portion 10, the full-rate carriage 131 and the half-rate carriage 132 travel on the rail surfaces 151R and 153R of the metal frame 15, which does not expand or contract greatly accompanying temperature changes. As a result, the image scanning accuracy can be less likely to be affected by the temperature changes.

In the image scanning portion 10, the metal frame 15 having high rigidity and dimensional accuracy is used only on portions where rigidity and dimensional accuracy are required in order to achieve the scanning accuracy. Therefore, even when using the plastic chassis, which also functions as the outer casing and has lower rigidity and dimensional accuracy, the image scanning accuracy can be achieved, and the number of components can be reduced.

### Other Preferred Embodiments

A description has been made of the image scanning optical system 13 using the mirror carriages 131 and 132, which reflect the light off the original document and guide the light towards the scanner unit 133. However, the present invention can be applied to an image scanner in which a carriage including a scanner unit can travel on the rail surfaces and the carriage is transported by the transport belt.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image scanning device comprising:
a plastic chassis arranged to define a framework of the image scanning device; and
a metal frame arranged in a ladder shape including bridge members welded to a separated pair of elongated members.

2. The image scanning device according to claim 1, wherein the metal frame is built in the plastic chassis.

3. The image scanning device according to claim 2, further comprising:
a platen glass on which an original document may be placed; and
a carriage which defines an image scanning optical system that scans the original document placed on the platen glass; wherein
the carriage is transported along the platen glass by transport belts, the transport belts are supported by supporting portions, and the supporting portions are held by the metal frame.

4. The image scanning device according to claim 3, wherein the image scanning optical system scans the original document placed on the platen glass, the image scanning optical system includes the carriage, and the carriage travels on upper surfaces of the supporting portions.

5. The image scanning device according to claim 4, wherein the plastic chassis defines an outer casing of the image scanning device.

6. The image scanning device according to claim 5, wherein the platen glass has two opposing portions respectively supported by upper edges of a front bulkhead and a rear bulkhead of the plastic chassis.

7. The image scanning device according to claim 6, wherein a plurality of embedding holes, in which the metal frame can be embedded, and an exposing hole, which exposes a scanner unit attaching portion of the metal frame, are provided in a bottom surface of the plastic chassis.

8. The image scanning device according to claim 7, wherein the metal frame is built in the plastic chassis by embedding the pair of elongated members into the pair of embedding holes provided in the plastic chassis.

9. The image scanning device according to claim 8, wherein the carriage includes a full-rate carriage having a light source and a mirror, and a half-rate carriage including a plurality of mirrors, wherein the full-rate and half-rate carriages are movably supported across surfaces of the elongated members.

10. An image scanning device comprising:
a plastic chassis defining an outer casing of the image scanning device;
a metal frame arranged in a ladder shape including bridge members welded to a separated pair of elongated members;
a full-rate carriage including a light source and a mirror; and
a half-rate carriage including a plurality of mirrors.

11. The image scanning device according to claim 10, wherein the full-rate carriage and the half-rate carriage are respectively fixed to transport belts, and are transported in response to a rotating movement of the transport belts.

12. The image scanning device according to claim 11, wherein the transport belt to which the full-rate carriage is attached, and the transport belt to which the half-rate carriage is attached, are respectively wound around a driving pulley and a driven pulley.

13. The image scanning device according to claim 12, wherein the driving pulley, on which the transport belt for the full-rate carriage is wound, and the driven pulley, on which the transport belt for the half-rate carriage is wound, are axially supported by a single shaft.

14. The image scanning device according to claim 13, wherein the shaft is rotatably held by shaft inserting holes respectively provided in side surfaces of the elongated members.

15. The image scanning device according to claim 14, wherein the driven pulley, on which the transport belt for the full-rate carriage is wound, and the driven pulley, on which the transport belt for the half-rate carriage is wound, are rotatably supported by a supporting bracket held by the metal frame.
